(19) United States
(12) Patent Application Publication
(10) Pub. No.: US 2012/0105964 A1
(43) Pub. Date: May 3, 2012

(54) LIGHT FILTER AND OPTICAL DEVICE

(75) Inventor: Seiji YAMAZAKI, Fujimi (JP)

(73) Assignee: SEIKO EPSON CORPORATION, Tokyo (JP)

(21) Appl. No.: 13/253,630

(22) Filed: Oct. 5, 2011

(30) Foreign Application Priority Data
Oct. 29, 2010 (JP) 2010-243301

(51) Int. Cl. G02B 26/00

(52) U.S. Cl. 359/578

(57) ABSTRACT

A light filter comprising a first substrate, a second substrate, a first optical film, a second optical film, a second bonding film, and a first bonding film, wherein the first optical film is formed to be a multilayer film in which a first optical substrate film, a first optical intermediate film, and a first optical surface film are stacked, the second optical film is formed to be a multilayer film in which a second optical substrate film, a second optical intermediate film, and a second optical surface film are stacked, a part of the first bonding film is one of the first optical substrate film and the first optical intermediate film, and a part of the second bonding film is one of the second optical substrate film and the second optical intermediate film.

### BACKGROUND

1. Technical Field

The present invention relates to a light filter and an optical device.

2. Related Art

In Patent Document 1 (JP-A-2009-134028), a light filter including a Fabry-Perot etalon filter having a pair of optical films opposed via a predetermined gap (hereinafter, may be referred to as “etalon filter”, or simply as “etalon”) has been disclosed.

The etalon filter described in Patent Document 1 has a first substrate and a second substrate held in parallel to each other, a first optical film (first reflection film) formed on the first substrate, and a second optical film (second reflection film) formed on the first substrate and opposed to the first optical film with a predetermined gap. The respective first optical film and second optical film form mirrors and may transmit only light in a predetermined wavelength range in response to the length of the gap (the amount of the gap) by multiple interference of light between the mirrors. Further, by variably controlling the amount of the gap, the wavelength range of light to be transmitted through may be shifted.

Furthermore, the etalon filter described in Patent Document 1 uses bonding films containing siloxane (Si—O) binding for bonding between the first substrate and the second substrate. The accuracy of wavelength separation in the etalon filter has a deep relationship with the accuracy of the amount of the gap. Therefore, to improve performance of the etalon filter, it is necessary to control the length of the gap between the first optical film and the second optical film with high accuracy, and, as a factor therefor, when the first substrate and the second substrate are bonded via the bonding films containing siloxane binding, it is important to ensure the parallelism between the respective substrates without slanting the respective substrates.

However, in the above described Patent Document 1, for bonding the respective substrates using the bonding films, for example, it is necessary to activate the bonding films formed on the respective substrates by ultraviolet radiation, oxygen plasma treatment, or the like, perform alignment of the respective substrates, and then, apply loads on the respective substrates, and the substrates may be slightly slanted at these steps.

As a cause of slanting of the substrates, it is considered that one of the causes of the slanting of the substrates is that slanting, rounding, or the like is easily formed in the edge parts of the bonding films, the slanting or rounding portions of the edge parts of the bonding films induce inhomogeneous deformation of the bonding films due to loads at bonding because of misalignment when the bonding films are partially formed on the respective substrates (bonding film misalignment) and substrate misalignment at the step of bonding the respective substrates to each other.

### SUMMARY

An advantage of some aspects of the invention is to provide an optical filter in which slanting of substrates due to bonding films is suppressed even when misalignment occurs and a gap between opposed optical films is uniform.

### Application Example 1

This application example of the invention is directed to an optical filter including a first substrate, a second substrate having a support part that supports the first substrate, a first optical film provided on the first substrate, a second optical film provided on the second substrate and oppositely placed to the first optical film, a first bonding film formed at least on a support surface of the support part of the first substrate, and a second bonding film formed at least in a region of the second substrate oppositely placed to the support surface of the support part of the first substrate, wherein the first optical film is formed to be a multilayer film in which a first optical substrate film, a first optical intermediate film, and a first optical surface film are stacked sequentially from the first substrate side toward the second optical film, the second optical film is formed to be a multilayer film in which a second optical substrate film, a second optical intermediate film, and a second optical surface film are stacked sequentially from the second substrate side toward the first optical film, a part of the first bonding film is one of the first optical substrate film and the first optical intermediate film, and a part of the second bonding film is one of the second optical substrate film and the second optical intermediate film.

According to this application example, since the parts of the bonding films form the partial layers of the optical films (mirror films), the bonding films are formed over the entire surfaces of the substrates in the manufacturing process. Therefore, the bonding surfaces are formed in a wider range than the bonding part regions of the substrates and, as a result, occurrence of slanting of the bonding films due to the pressure load applied at bonding may be suppressed and the gap between the optical films (mirrors) may be correctly formed. Thus, the light filter having high spectroscopic accuracy may be obtained.

### Application Example 2

This application example of the invention is directed to the optical filter of the above application example, wherein the first optical intermediate film is the part of the first bonding film, and the second optical intermediate film is the part of the second bonding film.

According to this described application example, spectroscopic performance of the optical film may be improved by increasing the difference in refractive index between the substrate film and the intermediate film, and, when the substrate material is general low-refractive-index glass, a high-refractive-index coating is formed for the substrate film. Therefore, the bonding film of the low-refractive-index coating may be easily used as the intermediate film.

### Application Example 3

This application example of the invention is directed to the optical filter of the above application example, wherein the first bonding film and the second bonding film are plasma-polymerized films.

According to this application example, when the first substrate and the second substrate are bonded, because the plasma-polymerized films are formed as the bonding films, strong bonding force may be obtained by activation treatment before bonding.

### Application Example 4

This application example of the invention is directed to the optical filter of the above application example, wherein the plasma-polymerized film contains an Si skeleton having siloxane binding and an elimination group bound to the Si skeleton.

According to this application example, advantageous bonding mechanical characteristics may be obtained, water-repellent coating may be changed to hydrophilic coating because activation energy is provided as activation treatment before bonding, and easier handling before bonding and higher bonding force after bonding may be obtained.

### Application Example 5

This application example of the invention is directed to an optical device including the light filter of the above described application example.

According to this application example, a light filter advantageous in spectroscopic performance may be mounted.

### BRIEF DESCRIPTION OF THE DRAWINGS

The invention will be described with reference to the accompanying drawings, wherein like numbers reference like elements.

FIG. 1A is a schematic appearance plan view of a light filter according to the first embodiment, FIG. 1B is a schematic sectional view of A-A′ part of FIG. 1A, and FIG. 1C is a schematic enlarged view of L part of FIG. 1B.

FIG. 2 is a graph showing refractive index characteristics of a plasma-polymerized film formed on the light filter according to the first embodiment.

FIGS. 3A and 3B are schematic appearance plan views showing other forms of bonding films according to the first embodiment.

FIG. 4 is a manufacturing flowchart of the light filter according to the first embodiment.

FIGS. 5A to 5C are schematic sectional views showing a manufacturing method of the light filter according to the first embodiment.

FIGS. 6D to 6F are schematic sectional views showing the manufacturing method of the light filter according to the first embodiment.

FIG. 7 is a schematic partial sectional view showing a manufacturing method of optical films according to the first embodiment.

FIGS. 8A and 8B are partial sectional views of optical film parts showing light filters according to another embodiment.

FIG. 9 is a block diagram showing an optical device according to the second embodiment.

### DESCRIPTION OF EXEMPLARY EMBODIMENTS

As below, embodiments according to the invention will be explained with reference to the drawings.

### First Embodiment

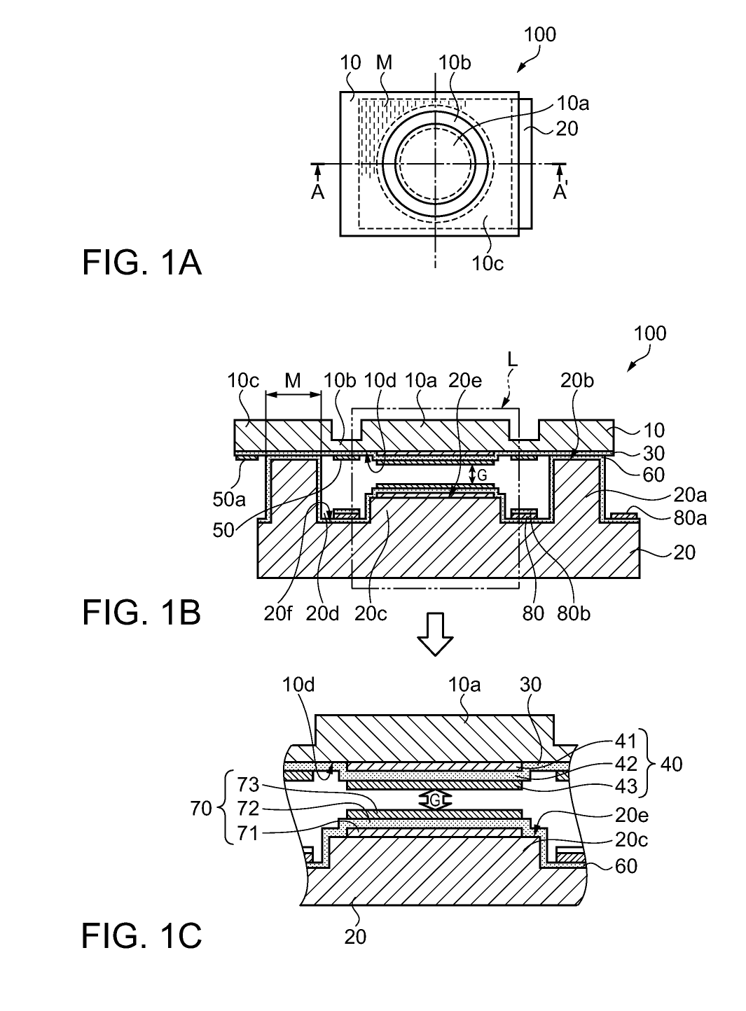

FIGS. 1A to 1C show a variable-gap etalon filter in which a gap between optical films can be variably controlled as an example of a light filter according to the embodiment, FIG. 1A is an appearance plan view, FIG. 1B is a sectional view of A-A′ part shown in FIG. 1A, and FIG. 1C is an enlarged view of L part shown in FIG. 1B. A variable-gap etalon filter 100 (hereinafter, referred to as “etalon filter 100”) includes a first substrate 10 and a second substrate 20 supported and fixed by a support surface 20b of a support part 20a of the second substrate 20 as shown in FIG. 1B.

As shown in FIGS. 1A and 1B, the first substrate 10 according to the embodiment is formed from a base material of quartz glass having a thickness of about 200 μm, and includes a diaphragm part 10b formed to have a thin thickness and a movable part 10a having a thicker thickness than that of the diaphragm part and connected to the inner side of the diaphragm part 10b in a nearly center part of the first substrate 10. Further, a holding part 10c that is connected to the outer side of the diaphragm part 10b and holds the movable part 10a via the diaphragm part 10b is provided, and forms the first substrate 10 together with the movable part 10a and the diaphragm part 10b. The surface of the first substrate 10 is polished into a mirror surface.

On a mirror formation surface 10d of the first substrate 10 opposed to the second substrate 20, a first bonding film 30 is formed to contain at least a region to be fixed to the support surface 20b of the support part 20a of the second substrate 20, which will be described later. As the first bonding film 30, for example, a film containing an Si skeleton having siloxane binding and an elimination group bound to the Si skeleton may be used, and may provide strong binding to a second bonding film 60 formed on the second substrate 20, which will be described later.

As shown in FIG. 1C, on the mirror formation surface 10d of the movable part 10a opposed to the second substrate 20, a first optical substrate film 41 is formed. The first optical substrate film 41 is formed in a thickness of about 30 nm using titanium oxide (TiO₂) or tantalum oxide (Ta₂O₅) having a higher refractive index than that of quartz glass forming the first substrate 10. On the surface opposite to the mirror formation surface 10d of the first optical substrate film 41, a part of the first bonding film 30 is formed as a first optical intermediate film 42.

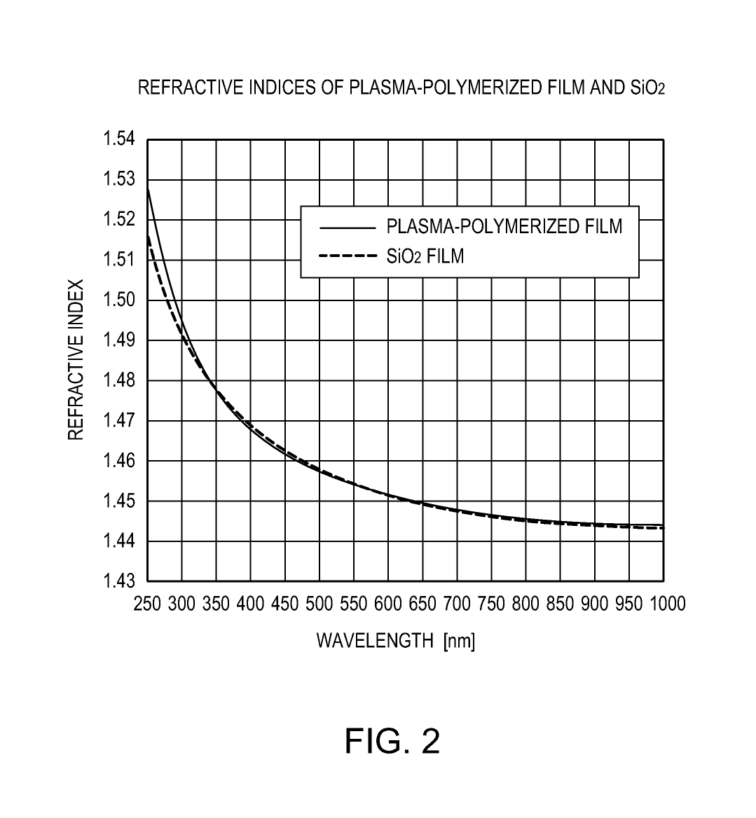

The first optical intermediate film 42 is a film containing the Si skeleton having siloxane binding and the elimination group bound to the Si skeleton as described above, and has a refractive index equal to that of a silicon oxide (SiO₂) film that has been used in related art in a wide wavelength region as shown in FIG. 2, and has a refractive index sufficiently lower than that of TiO₂ or Ta₂O₅ film formed as the first optical substrate film 41. Thus, the part of the first bonding film 30 may be used as the first optical intermediate film 42.

On the opposite side to the first optical substrate film 41 of the first optical intermediate film 42, a first optical surface film 43 is formed. The first optical surface film 43 is formed in a thickness of 30 to 40 nm using a metal film of only silver or a silver alloy of Ag, AgC, AgCu, AgSnCu, or the like, for example, or only Al. In this manner, the first optical substrate film 41, the first optical intermediate film 42, and the first optical surface film 43 are stacked and form a first optical film 40 having both a reflection property and a transmission property for light in a desired wavelength band.

Further, in the diaphragm part 10b region on the mirror formation surface 10d of the first substrate 10, a first actuator electrode 50 is formed and connected to a first external connection electrode 50a via internal wiring (not shown).

Next, the second substrate 20 will be explained. The second substrate 20 is formed from a substrate of quartz glass having a thickness of about 200 μm like the first substrate 10, and includes a mirror formation part 20c for formation of a second optical film 70 opposed to the first optical film 40, the support part 20a that supports the first substrate 10, and a recess part 20d between the support part 20a and the mirror formation part 20c at the side oppositely placed to the first substrate 10. The surface of the second substrate 20 is polished into a mirror surface. At the bottom of the recess part 20d, a second actuator electrode 80 provided oppositely to the first actuator electrode 50 is placed.

At least on the support surface 20b of the support part 20a of the second substrate 20, the second bonding film 60 is formed. As the second bonding film 60, like the first bonding film 30, for example, a film containing an Si skeleton having siloxane binding and an elimination group bound to the Si skeleton may be used, and may provide strong binding to the first bonding film 30 formed on the first substrate 10.

On a mirror formation surface 20e opposed to the first optical film 40 of the mirror formation part 20c, a second optical substrate film 71 is formed. The second optical substrate film 71 is formed in a thickness of about 30 nm using titanium oxide (TiO₂) or tantalum oxide (Ta₂O₅) having a higher refractive index than that of quartz glass forming the second substrate 20 like the first optical substrate film 41. On the surface opposite to the mirror formation surface 20e of the second optical substrate film 71, a part of the second bonding film 60 is formed as a second optical intermediate film 72.

On the opposite side to the second optical substrate film 71 of the second optical intermediate film 72, a second optical surface film 73 is formed. The second optical surface film 73 is formed in a thickness of 30 to 40 nm using a metal film of only silver or a silver alloy of Ag, AgC, AgCu, AgSnCu, or the like, for example, or only Al like the first optical surface film 43. In this manner, the second optical substrate film 71, the second optical intermediate film 72, and the second optical surface film 73 are stacked and form the second optical film 70 having both a reflection property and a transmission property for light in a desired wavelength band.

On a bottom surface 20f of the recess part 20d, the second actuator electrode 80 is formed in a position opposed to the first actuator electrode 50 and connected to a second external connection electrode 80a via internal wiring (not shown). Further, on the surface of the second actuator electrode 80, a protective film 80b is formed. The protective film 80b is formed by forming a TEOS film on the second actuator electrode 80 surface except the second external connection electrode in a thickness of about 0.1 μm, for example. Then, the first actuator electrode 50 and the second actuator electrode 80 are connected to an actuator drive circuit via the first external connection electrode 50a and the second external connection electrode 80a.

As described above, the first bonding film 30 and the second bonding film 60 formed on the first substrate 10 and the second substrate 20 are activated by ultraviolet radiation, oxygen plasma treatment, or the like. Then, the first substrate 10 and the second substrate 20 are provided so that the first bonding film 30 and the second bonding film 60 may be opposed, the first substrate 10 is aligned in the plan view and mounted on the support surface 20b of the support part 20a of the second substrate 20, the respective substrates are bonded by application of loads thereon while a gap G between the first optical film 40 and the second optical film 70 is maintained in a predetermined gap, and thereby, the etalon filter 100 is formed.

In the above described etalon filter 100, the part of the first bonding film 30 has been explained as the first optical intermediate film 42 and the part of the second bonding film 60 has been explained as the second optical intermediate film 72, and they will be explained more specifically. In FIGS. 1A and 1B for explanation of the embodiment, the first bonding film 30 and the second bonding film 60 are formed in M region shown as a region where the first substrate 10 and the second substrate 20 are bonded and over the inner side entire surface in the M region. Thus formed first bonding film 30 functions as the first optical intermediate film 42 in the formation region of the first optical film 40. Further, similarly, the second bonding film 60 functions as the second optical intermediate film 72 in the formation region of the second optical film 70. That is, the description that the bonding film formed over the nearly entire surface is formed as the part of the optical film forming the optical film in the optical film formation region means that the part of the bonding film is formed as the optical intermediate film.

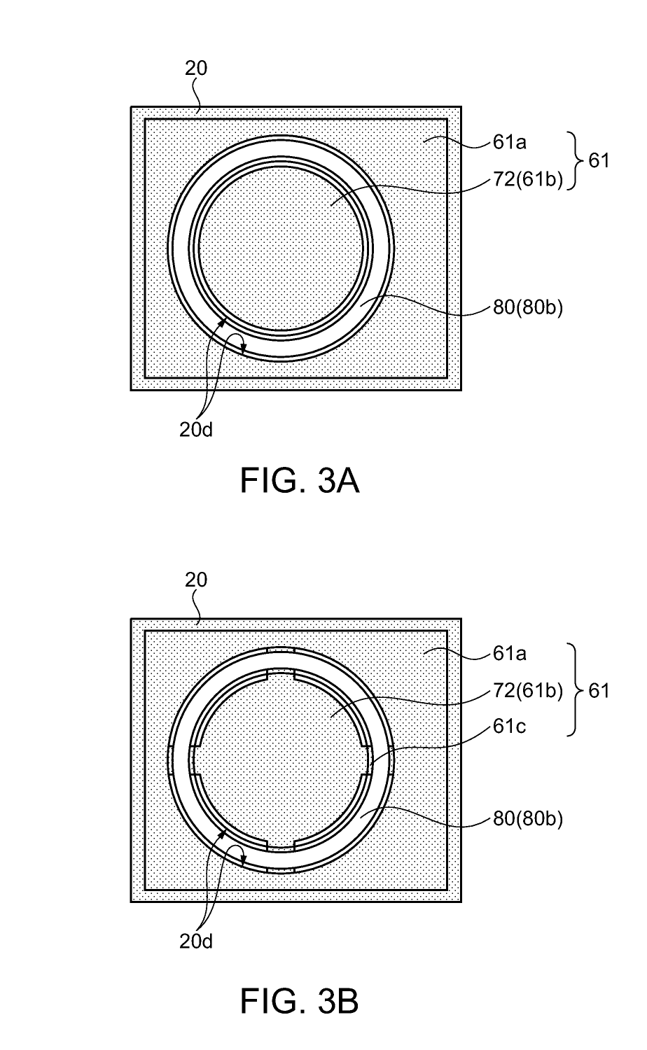

However, not only the configuration in which the part of the above described entire surface bonding film is formed in one layer of the optical film, but also a configuration in which a second bonding film 61a formed on the support surface 20b of the support part 20a and a second bonding film 61b forming the second optical intermediate film 72 of the second optical film 70 are separated may be employed as shown in a schematic appearance plan view of the bonding film arrangement of the second substrate 20 in FIG. 3A, for example. In this case, the second bonding films 61a, 61b are formed at the same time as the second bonding film 61 and obtained by removing the second bonding film in parts except the second bonding films 61a, 61b in the manufacturing process, which will be described later, and they are in the category of formation of the part of the bonding film as the optical intermediate film.

Further, as shown by one example of FIG. 3B, even in the case where the second bonding films 61a and 61b in FIG. 3A are partially connected by a second bonding film 61c to form the second bonding film 61, they are in the category of formation of the part of the bonding film as the optical intermediate film. Note that the form of the second bonding film 61c is not limited to the form shown in FIG. 3B as long as the second bonding films 61a and 61b may be partially connected. Although the second substrate 20 has been exemplified for explanation, also, in the first substrate 10, the first bonding film 30 formed on the nearly entire surface may have a function of the first optical intermediate film 42 in the formation region of the first optical film 40, or the first bonding film 30 may be separated into the bonding region M (see FIGS. 1A and 1B) and the region of the first optical film 40. Alternatively, the separated bonding films may be partially connected. Furthermore, the above described various forms of the bonding films may use different forms between the first substrate 10 and the second substrate 20, or the same form. The first bonding film 30 and the second bonding film 60 are formed as described above, and thereby, adhesion between the first actuator electrode 50 and the first substrate 10 and between the second actuator electrode 80 and the second substrate 20 may be improved and driving of the diaphragm part 10b may be stably performed.

The etalon filter 100 according to the above described embodiment may reflect and interfere light entering from the outside of the first substrate 10, for example, in the gap G between the first optical film 40 and the second optical film 70 and output only light having a desired specific wavelength from the opposite side to the incident side of the light. Further, the movable part 10a of the first substrate 10 electrostatically drives the diaphragm part 10b, and thereby, the gap G may be changed. Therefore, the etalon filter 100 according to the embodiment has the configuration of the so-called tunable interference filter that may set the wavelength of the output light by the setting of the variable gap G. However, the invention may be applied to an interference filter for a fixed wavelength without including the movable part 10a, the diaphragm part 10b, the first actuator electrode 50, or the second actuator electrode 80 for wavelength tunability.

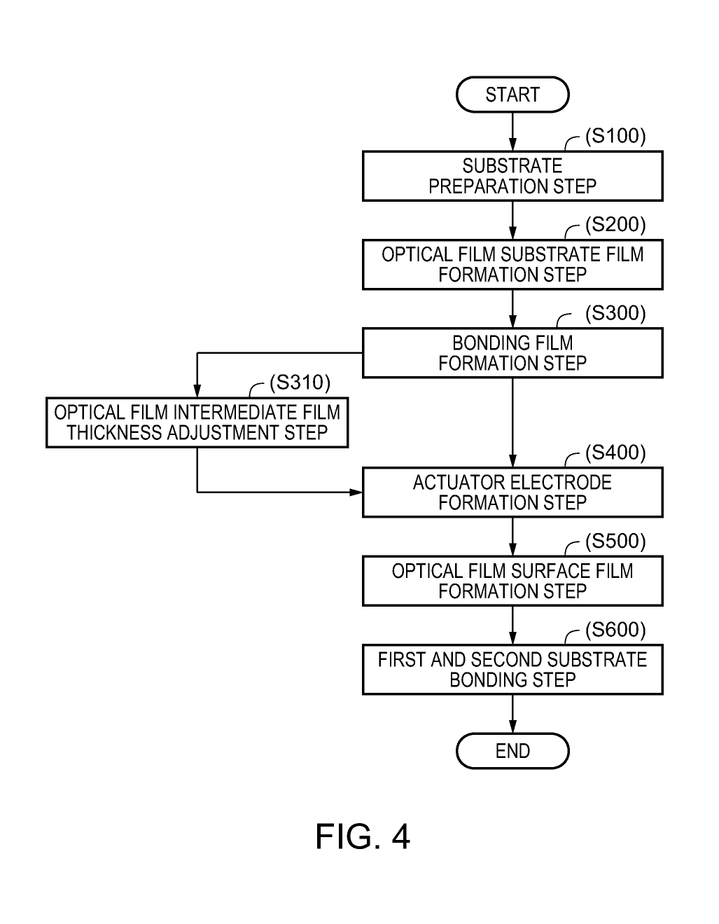

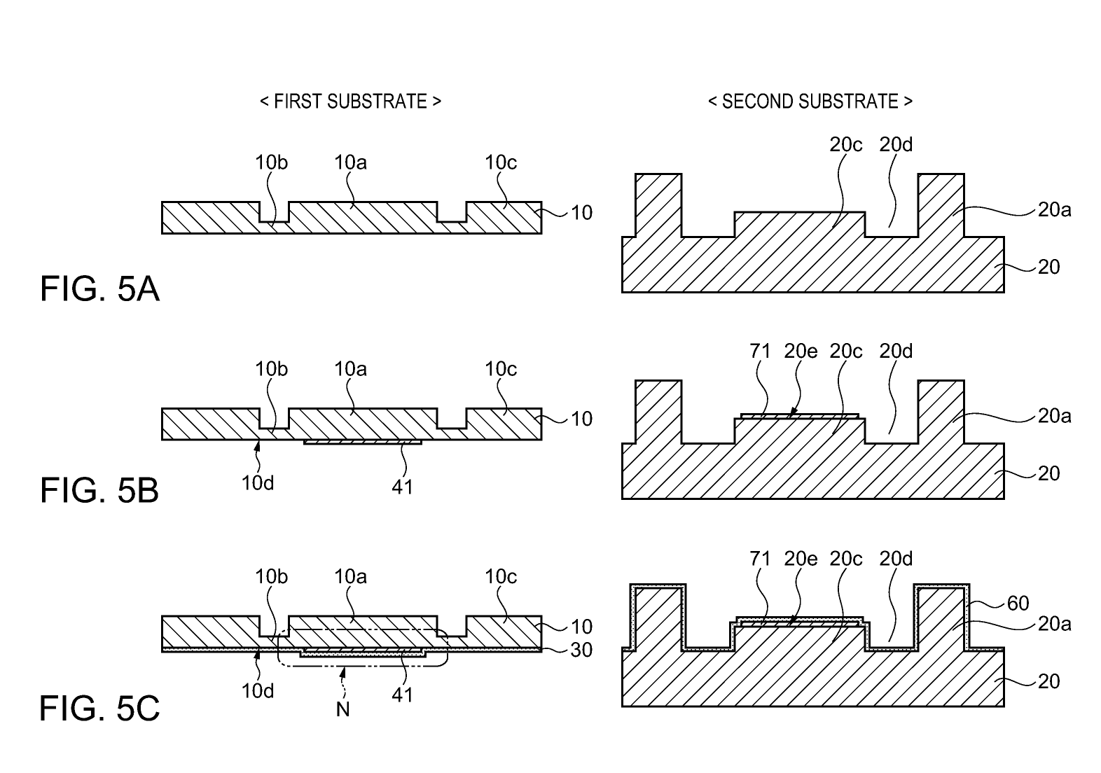

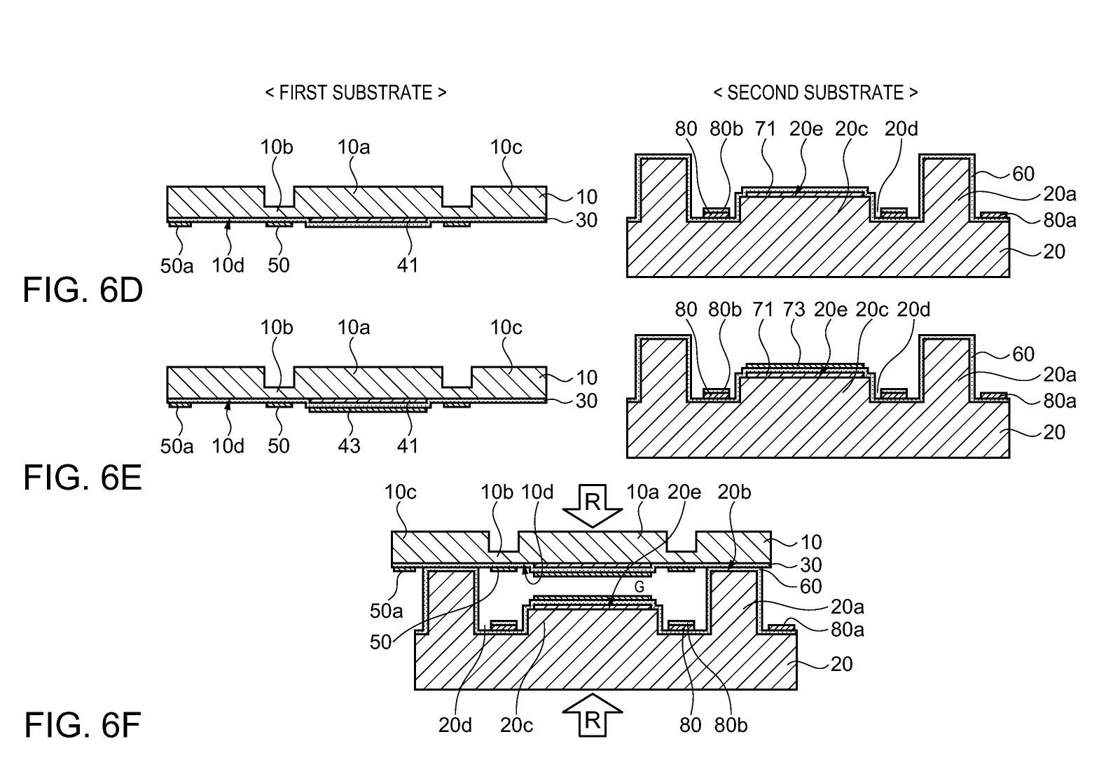

Next, an outline of a manufacturing method of the etalon filter 100 according to the embodiment will be explained. FIG. 4 is a flowchart showing a manufacturing process flow of the etalon filter 100 according to the embodiment. Further, FIGS. 5A to 6F are schematic sectional views showing a manufacturing method of the first substrate 10 and the second substrate 20 at the respective manufacturing steps.

First, as shown in FIG. 5A, the first substrate 10 with the movable part 10a, the diaphragm part 10b, and the holding part 10c worked thereon in advance and the second substrate 20 with the support part 20a, the mirror formation part 20c, and the recess part 20d worked thereon in advance are prepared (S100). As described above, the first substrate 10 and the second substrate 20 may be obtained by performing formation of the predetermined parts by patterning and etching of known resist materials on the substrates of about 200 μm of the transparent base material such as quartz glass, for example. Further, at S100, cleansing and drying are performed as preparation for the subsequent process and the first substrate 10 and the second substrate 20 are cleaned.

Then, the process moves to a substrate film formation step (S200) of forming the first optical substrate film 41 and the second optical substrate film 71 as the substrate side films of the optical films. As shown in FIG. 5B, at the substrate film formation step (S200), the first optical substrate film 41 is formed on the mirror formation surface 10d at the side opposed to the second substrate 20 of the first substrate 10, and the second optical substrate film 71 is formed on the mirror formation surface 20e of the upper surface of the mirror formation part 20c of the second substrate 20. As the film formation method, the films are formed in the following manner that the resist material in which the formation regions of the first optical substrate film 41 and the second optical substrate film 71 are opened is patterned, the films of TiO₂ or Ta₂O₅ as the substrate film material are formed in 50 nm by evaporation or sputtering, and the patterned resist materials are removed.

Then, the process moves to a bonding film formation step (S300). At the bonding film formation step (S300), as shown in FIG. 5C, on the entire surfaces of the first substrate 10 and the second substrate 20 oppositely placed to each other, the first bonding film 30 is formed on the first substrate 10 and the second bonding film 60 is formed on the second substrate 20. As the bonding films, plasma-polymerized films are formed in thicknesses of 50 nm by the plasma CVD method. As the plasma-polymerized film, a film containing an Si skeleton having siloxane binding and an elimination group bound to the Si skeleton is preferably used.

In the case of the partially removed form of the second bonding film 61 that has been explained in the second substrate 20 as shown in FIGS. 3A and 3B, at the bonding film formation step (S300), the second bonding film 61 may be obtained by forming a mask having openings corresponding to the parts to be removed by patterning of a resist material and partially removing the second bonding film 60 by a method such as etching. Note that, also, in the first substrate 10, the first bonding film 30 may be partially removed in the same method.

At the bonding film formation step (S300), the first bonding film 30 and the second bonding film 60 are formed in thicknesses of 50 nm for ensuring bonding strength. However, it is preferable that the part of the first bonding film 30 forming the first optical intermediate film 42 and the part of the second bonding film 60 forming the second optical intermediate film 72 have thicknesses of 20 to 30 nm for proper optical properties of the first optical film 40 and the second optical film 70. Accordingly, after the bonding film formation step (S300), an intermediate film thickness adjustment step (S310) may be performed.

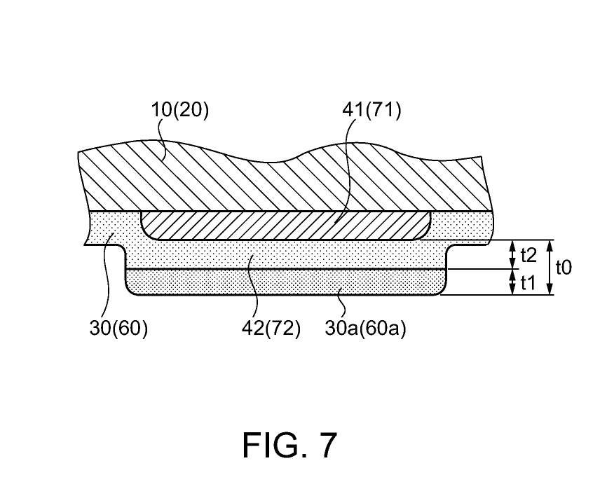

At the intermediate film thickness adjustment step (S310), as shown in FIG. 7 in which N part of the first substrate 10 in FIG. 5C is enlarged, the first bonding film 30 that has been formed at the bonding film formation step (S300) is formed in a thickness of t0 on the first optical substrate film 41. As described above, the thickness t0 is 50 nm. For improvement of the optical properties, thickness t1 is removed from the thickness t0 to thickness t2 as thickness adjustment. As a removal method, a known method such as laser or etching, for example, can be preformed. The first bonding film 30 is adjusted to the thickness t2 as the first optical intermediate film 42 advantageous in optical properties. The thickness t2 is adjusted to an optimal thickness of 20 to 30 nm as the preferable thickness. Note that, also, in the second bonding film 60 in the second substrate 20, in the same manner as the above described first bonding film 30, the thickness of the second optical intermediate film 72 part may be adjusted.

After the bonding film formation step (S300) or the intermediate film thickness adjustment step (S310), the process moves to an actuator electrode formation step (S400). At the actuator electrode formation step (S400), as shown in FIG. 6D, the first actuator electrode 50 in a doughnut shape, the first external connection electrode 50a, and wiring (not shown) connecting the first actuator electrode 50 and the first external connection electrode 50a are formed at the mirror formation surface 10d side corresponding to the diaphragm part 10b in the first substrate 10.

The first actuator electrode 50, the first external connection electrode 50a, and the wiring (not shown) connecting the first actuator electrode 50 and the first external connection electrode 50a are formed in the following manner. An ITO (Indium Tin Oxide) film is formed in a thickness of 0.1 μm by sputtering on the substrate surface at the electrode formation side. Then, a resist material is patterned to cover formation regions of the first actuator electrode 50, the first external connection electrode 50a, and the wiring (not shown) connecting the first actuator electrode 50 and the first external connection electrode 50a, and the parts other than the first actuator electrode 50, the first external connection electrode 50a, and the wiring (not shown) connecting the first actuator electrode 50 and the first external connection electrode 50a are removed by etching.

Also, in the second substrate 20, like the first substrate 10, the second actuator electrode 80, the second external connection electrode 80a, and the wiring (not shown) connecting the second actuator electrode 80 and the second external connection electrode 80a are formed in the bottom surface part of the recess part 20d by an ITO film. Then, a mask in which upper surfaces of the second actuator electrode 80, and the wiring (not shown) connecting the second actuator electrode 80 and the second external connection electrode 80a are opened is formed by patterning of a resist material, a TEOS (tetraethoxysilane) film is formed on the upper surfaces of the second actuator electrode 80, and the wiring (not shown) connecting the second actuator electrode 80 and the second external connection electrode 80a by the CVD method, and thereby, the protective film 80b is formed as an insulation film. Note that, like the second substrate 20, a TEOS film may be formed on the upper surfaces of the above described first actuator electrode 50 and the wiring (not shown) connecting the first actuator electrode 50 and the first external connection electrode 50a of the first substrate 10.

Next, the process moves to a surface film formation step (S500). At the surface film formation step (S500), as shown in FIG. 6E, the first optical surface film 43 is formed on the first substrate 10 and the second optical surface film 73 is formed on the second substrate 20. At the surface film formation step (S500), coatings as mirrors on the uppermost surfaces of the first and second optical films 40 and 70 are formed in thicknesses of 50 nm at the mirror formation surface 10d side of the first substrate 10 first preferably using a metal as a mirror material of Ag, for example, AgC, AgCu, AgSnCu as an Ag alloy, Al, or an Al alloy by evaporation or sputtering of the metal or metal alloy on the first substrate 10. A mask covering the formation region of the first optical surface film 43 is formed on the formed coating by patterning of a resist material, the coating other than the first optical surface film 43 is removed by etching, and thereby, the first optical surface film 43 is formed.

Regarding the second optical surface film 73 in the second substrate 20, the second optical surface film 73 using a metal or metal alloy is formed in the same manner as that of the above described first optical surface film 43. In the process to the surface film formation step (S500), the first substrate 10 and the second substrate 20 are completed.

Then, the process moves to a bonding step (S600). At the bonding step (S600), for activation of the first bonding film 30 and the second bonding film 60, first, O₂ plasma treatment or UV radiation treatment is performed. In the case of O₂ plasma treatment, it is preferable that the treatment is performed for 30 seconds under the condition that flow is 30 cc/min, pressure is 27 Pa, and RF power is 200 W. Further, in the case of UV radiation treatment, it is preferable that the treatment is performed for three minutes using excimer UV (wavelength 172 nm). Note that, in the activation treatment, when the above described energy of the activation treatment is applied to the first optical surface film 43 and the second optical surface film 73 as the uppermost surfaces of the first optical film 40 and the second optical film 70, damage (flaw) occurs on the coatings, and therefore, it is preferable that the surfaces of the first optical surface film 43 and the second optical surface film 73 are protected using a metal mask or the like (not shown).

Thus activated first bonding film 30 and second bonding film 60 are opposed, loads R are applied thereto as shown in FIG. 6F, the films are bonded in corresponding regions of the support part 20a of the second substrate 20, and thereby, the etalon filter 100 is obtained. In this regard, alignment adjustment between the first substrate 10 and the second substrate 20 before bonding should be performed correctly so that the gap G between the first optical film 40 and the second optical film 70 shown in FIGS. 1A to 1C may be uniform. In the etalon filter 100 according to the embodiment, the bonding film comes over the region of the support surface 20b in the support part 20a to form the second bonding film 60 and comes over the region corresponding to the support surface 20b also in the first substrate 10 to form the first bonding film 30. Thereby, despite of misalignment, the uniformity of the gap G, in other words, the parallelism between the first optical film 40 and the second optical film 70 is easily maintained, and advantageous filter characteristics may be provided.

### Modified Example

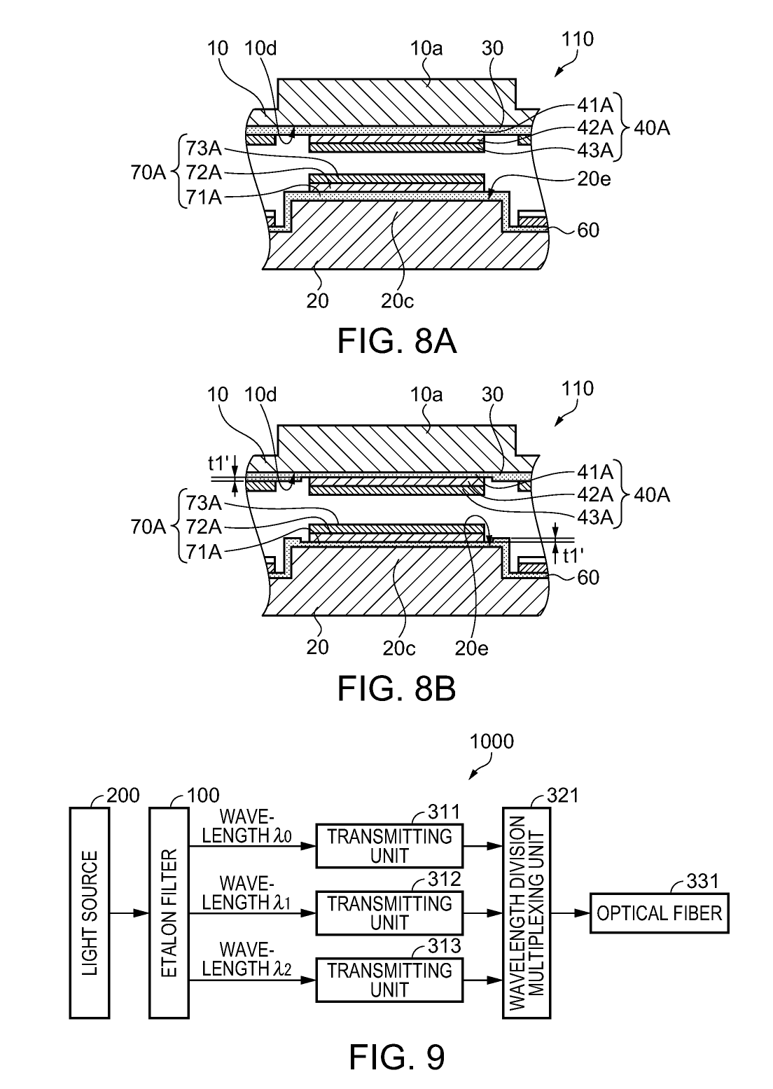

In the etalon filter 100 according to the above described embodiment, a configuration of an optical film when using a high-refractive-index material for the substrate material will be explained as another embodiment. FIGS. 8A and 8B are schematic sectional views of an etalon filter 110 according to the other embodiment corresponding to the L part in FIG. 1B. The embodiment is different only in the configurations of the first optical film 40 and the second optical film 70 and the base material used for the first substrate 10 and the second substrate 20 in the etalon filter 100 according to the above described embodiment, and the explanation of the common configuration will be omitted.

In the etalon filter 110 according to the other embodiment, as shown in FIG. 8A, a transparent base material having a higher refractive index than that of quartz glass used in the above described etalon filter 100 is used for the base material used for the first substrate 10 and the second substrate 20. As the transparent base material, for example, sapphire, zinc selenide (ZnSe), or high-refractive-index glass, for example, LaSFN9, SF11 (manufactured by SCHOTT), or the like is preferably used. In the case where a high-refractive-index transparent base material is used for the base material of the first substrate 10 and the second substrate 20, a first optical film 40A and a second optical film 70A may have the following configuration.

As shown in FIG. 8A, in the first substrate 10, a first optical substrate film 41A of the first optical film 40A is formed from a part of the first bonding film 30 containing an Si skeleton having siloxane binding and an elimination group bound to the Si skeleton. For a first optical intermediate film 42A, a film of TiO₂ or Ta₂O₅ having a high refractive index is formed because the first bonding film 30 as the first optical substrate film 41A has a low refractive index. According to the configuration, the first optical film 40A advantageous in reflection properties may be obtained. Note that a first optical surface film 43A is the same as the first optical surface film 43 of the above described etalon filter 100.

A second optical film 70A of the second substrate 20 has the same configuration as that of the above described first optical film 40A, a second optical substrate film 71A is formed from a part of the second bonding film 60, and a second optical intermediate film 72A has the same configuration as that of the first optical intermediate film 42A.

FIG. 8B is a sectional view showing the case where thickness adjustment of the bonding films performed for the first optical substrate film 41A and the second optical substrate film 71A of the above described etalon filter 110 at the above described intermediate film thickness adjustment step (S310) is performed. That is, the thicknesses of the optical film formation regions in the first bonding film 30 and the second bonding film 60 are removed by t1′ shown in the drawing, and the first optical substrate film 41A and the second optical substrate film 71A more advantageous in optical properties may be obtained. Note that the removal method of t1′ may be performed in the same manner as that at the above described intermediate film thickness adjustment step (S310).

In the above described light filter according to the invention, since the parts of the bonding films form the partial layers of the optical films (mirror films), the bonding films are formed over the entire surfaces of the substrates in the manufacturing process. Therefore, the bonding surfaces are formed in a wider range than the bonding part regions of the substrates and, as a result, occurrence of slanting of the bonding films due to the pressure load applied at bonding may be suppressed and the gap between the optical films (mirrors) may be correctly formed. Thus, the light filter having high spectroscopic accuracy may be obtained. Further, since the parts of the bonding films form the parts of the optical films, the cost can be reduced by reduction of manufacturing man-hour.

### Second Embodiment

FIG. 9 is a block diagram showing a schematic configuration of a transmitter of a wavelength division multiplexing communication system as an example of an optical device. In wavelength division multiplexing (WDM) communication, if plural light signals having different wavelengths are used in a multiplexing manner within one optical fiber utilizing the characteristic that signals having different wavelengths do not interfere with each other, the amount of data transmission may be improved without increasing the lines of optical fibers.

In FIG. 9, a wavelength division multiplexing transmitter 1000 has the etalon filter 100 to which light from a light source 200 enters, and lights having plural wavelengths λ0, λ1, λ2, . . . are transmitted through the etalon filter 100 (including the etalon filter employing any one of the mirror structures). Transmitting units 311, 312, 313 are provided with respect to each wavelength. Light pulse signals for plural channels from the transmitting units 311, 312, 313 are combined into one in a wavelength division multiplexing unit 321 and sent out to one optical fiber transmission path 331.

The invention may be similarly applied to an optical code division multiplexing (OCDM) transmitter. The OCDM identifies channels by pattern matching of coded light pulse signals because light pulses of the light pulse signals contain light components having different wavelengths. In this manner, by applying the invention to an optical device, an optical device (for example, various kinds of sensors and optical communication applied device) with highly reliability in which property degradation of optical films is suppressed is realized.

As described above, according to at least one embodiment of the invention, for example, in a light filter formed by bonding of substrates, for example, slanting of the substrates may be suppressed and parallelism between optical films provided on the respective substrates may be ensured. The invention is preferably applied to an interference light filter like the etalon filter, for example. Not limited to the example, but the invention may be applied as a mirror structure to general structures (components and devices) using optical films having both light reflection properties and light transmission properties.

The entire disclosure of Japanese Patent Application No. 2010-243301, Oct. 29, 2010 filed is expressly incorporated by reference herein.

What is claimed is:

1. A light filter comprising:
a first substrate;
a second substrate having a support part that supports the first substrate;
a first optical film provided on the first substrate;
a second optical film provided on the second substrate and oppositely placed to the first optical film;
a second bonding film formed at least on a support surface of the support part of the second substrate; and
a first bonding film formed at least in a region of the first substrate oppositely placed to the support surface of the support part of the second substrate,
wherein the first optical film is formed to be a multilayer film in which a first optical substrate film, a first optical intermediate film, and a first optical surface film are stacked in order from the first substrate toward the second optical film,
the second optical film is formed to be a multilayer film in which a second optical substrate film, a second optical intermediate film, and a second optical surface film are stacked in order from the second substrate toward the first optical film,
a part of the first bonding film is one of the first optical substrate film and the first optical intermediate film, and
a part of the second bonding film is one of the second optical substrate film and the second optical intermediate film.

2. The light filter according to claim 1, wherein the first optical intermediate film is the part of the first bonding film, and
the second optical intermediate film is the part of the second bonding film.

3. The light filter according to claim 1, wherein the first bonding film and the second bonding film are plasma-polymerized films.

4. The light filter according to claim 3, wherein the plasma-polymerized film contains a Si skeleton having siloxane binding and an elimination group bound to the Si skeleton.

5. An optical device comprising the light filter according to claim 1.

6. An optical device comprising the light filter according to claim 2.

7. An optical device comprising the light filter according to claim 3.

8. An optical device comprising the light filter according to claim 4.

9. The light filter according to claim 1, wherein the first optical substrate film is the part of the first bonding film, and
the second optical substrate film is the part of the second bonding film.

10. The light filter according to claim 9, wherein a thickness of the first optical substrate film is smaller than a thickness of the first bonding film.

11. The light filter according to claim 10, wherein a thickness of the second optical substrate film is smaller than a thickness of the second bonding film.

12. The light filter according to claim 1, wherein the first optical substrate film is formed in contact with a surface of the first substrate, and
the second optical substrate film is formed in contact with a surface of the second substrate.

13. The light filter according to claim 2, wherein the second optical intermediate film is away from the second bonding film.

14. The light filter according to claim 2, wherein the second optical intermediate film is partially connected to the second bonding film.

15. A light filter comprising:
a first substrate;
a first optical film provided on the first substrate;
a first bonding film provided on the first substrate;
a second substrate;
a second optical film provided on the second substrate; and
a second bonding film provided on the second substrate,
wherein the first optical film includes a first optical substrate film, a first optical intermediate film, and a first optical surface film in order from the first substrate toward the second optical film,
the second optical film includes a second optical substrate film, a second optical intermediate film, and a second optical surface film in order from the second substrate toward the first optical film,
a material of the first bonding film is the same as a material of the first optical intermediate film, and
a material of the second bonding film is the same as a material of the second optical intermediate film.
